(19) United States
(12) Patent Application Publication
(10) Pub. No.: US 2022/0124577 A1
(43) Pub. Date: Apr. 21, 2022

(54) Handover Forking Support for Improving Handover Success Rate in LTE

(71) Applicant: Parallel Wireless, Inc., Nashua, NH (US)

(72) Inventors: Kartik Shashikant Raval, Pune (IN); Pratik Mehta, Pune (IN); Vivek Pise, Pune (IN); Anoop Gupta, Pune (IN); Gaurav Goel, Pune (IL); Ido Shaked, Alfei Menashe (IL)

(21) Appl. No.: 17/504,499

(22) Filed: Oct. 18, 2021

Related U.S. Application Data
(60) Provisional application No. 63/092,535, filed on Oct. 16, 2020.

(51) Int. Cl. H04W 36/00; H04W 36/38; H04W 36/32

(52) U.S. Cl. CPC H04W 36/00835; H04W 88/16; H04W 36/32; H04W 36/38

(57) ABSTRACT

A method, system and computer-readable media are presented for providing forked handover. In one embodiment a method includes building, by a HetNet Gateway (HNG), a cache of all neighbors of a source cell; organizing a list of cells, the list including an original target cell and at least one additional target cell; when a handover determination is to be made, determining the most probable additional cells where a User Equipment (UE) may land if it does not go to the original target cell; duplicating, by the HNG, indirect forwarding data packets coming in from the UE and sending the packets to all additional target cells; and canceling, by the HNG, handovers from all cells other than the target cell target which catches the UE.

### CROSS-REFERENCE TO RELATED APPLICATIONS

This application claims priority under 35 U.S.C. § 119(e) to U.S. Provisional Pat. App. No. 63/092,535, filed Oct. 16, 2020, titled “Handover Forking Support for Improving Handover Success Rate in LTE” which is hereby incorporated by reference in its entirety for all purposes. The present application hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and Ser. No. 15/713,584 (PWS-71850US03). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

### BACKGROUND

LTE/4G subscribers are always connected and demand for data has also gone exponentially high. Concomitantly, the number of connected mode handovers have also increased. Handovers always pose challenges when the subscribers are moving. When initiating handover, the source cell cannot apply the same algorithm for a moving subscriber as it applies to a fixed subscriber. The direction of the moving subscriber also plays a role in choosing the target eNodeB to initiate the handover to. It is observed in field that even though UE measurements do indicate the best neighbor that UE is able to see at-the-moment, the radio conditions change very frequently for a moving UE and many times, it tries to latch on to a different nearby target. That target is not prepared for the UE and hence the mobility is not seamless. This proposal tries to solve the problem so that higher number of handovers are successful giving better user experience.

In LTE, the specifications define a handover mechanism where connected mode subscribers move from one LTE cell to another if they can get better radio signal from the target cell. The handover is triggered by the source cell based on inputs from the subscriber. The subscriber (UE) measures the neighboring cells upon command from source cell and provides the measurement results to the source cell.

Forking may be performed at an intermediate, gateway node in the operator network to cause multiple handover messages to be generated upon a handover request; as a single UE may only be attached to one base station at a time, the base station in the vicinity of the requesting UE is configured to respond and complete the handover.

### SUMMARY

A method, system and computer readable media for providing forked handover are described. In one embodiment, a method includes building, by a HetNet Gateway (HNG), a cache of all neighbors of a source cell. The method also includes organizing a list of cells, the list including an original target cell and at least one additional target cell. When a handover determination is to be made, the method determines the most probable additional cells where a User Equipment (UE) may land if it does not go to the original target cell. The method further includes duplicating, by the HNG, indirect forwarding data packets coming in from the UE and sending the packets to all additional target cells; and canceling, by the HNG, handovers from all cells other than the target cell target which catches the UE.

In another example embodiment a system for providing forked handover includes a HetNet Gateway (HNG) in communication with a source cell, an original target cell, and an additional target cell. The HNG builds a cache of all neighbors of a cell, and organizes a list of cells. When a handover determination is to be made, the system determines the most probable adjacent cells where a User Equipment (UE) may land if it does not go to an actual target and duplicates indirect forwarding data packets coming in from a source and send the packets to all prepared cells. The system cancels handovers from all cells other than the cell target which catches the UE.

In another embodiment, a non-transitory computer-readable medium contains instructions for providing forked handover, which, when executed, cause a system to perform forked handover. The computer-readable media include instructions for building, by a HetNet Gateway (HNG), a cache of all neighbors of a source cell. The computer-readable media include instructions for organizing a list of cells, the list including an original target cell and at least one additional target cell. When a handover determination is to be made, the computer-readable media include instructions for determining the most probable additional cells where a User Equipment (UE) may land if it does not go to the original target cell. The computer-readable media includes instructions for duplicating, by the HNG, indirect forwarding data packets coming in from the UE and sending the packets to all additional target cells; and canceling, by the HNG, handovers from all cells other than the target cell target which catches the UE.

### BRIEF DESCRIPTION OF THE DRAWINGS

FIG. 1 is a diagram showing a system for performing forked handover in accordance with some embodiments.

FIGS. 2A and 2B is a call flow for performing forked handover in accordance with some embodiments.

FIG. 3 is a schematic network architecture diagram for 3G and other-G prior art networks.

FIG. 4 is an enhanced eNodeB for performing the methods described herein, in accordance with some embodiments.

FIG. 5 is a coordinating server for providing services and performing methods as described herein, in accordance with some embodiments.

### DETAILED DESCRIPTION

In urban/semi-urban conditions, an operator deploys many ENodeBs to supplement the capacity and coverage for many subscribers. Also, radio conditions of a UE changes frequently especially in urban/semi-urban environments. As the UE moves around, different obstructions in the radio path can make it see completely different set of best neighboring cells. When the handover is initiated, it is difficult to predict whether the best cell chosen at that moment may remain the best cell in next few moments when the handover completes. One such use case is shown here for reference where a fast moving UE may select different cell than the original target.

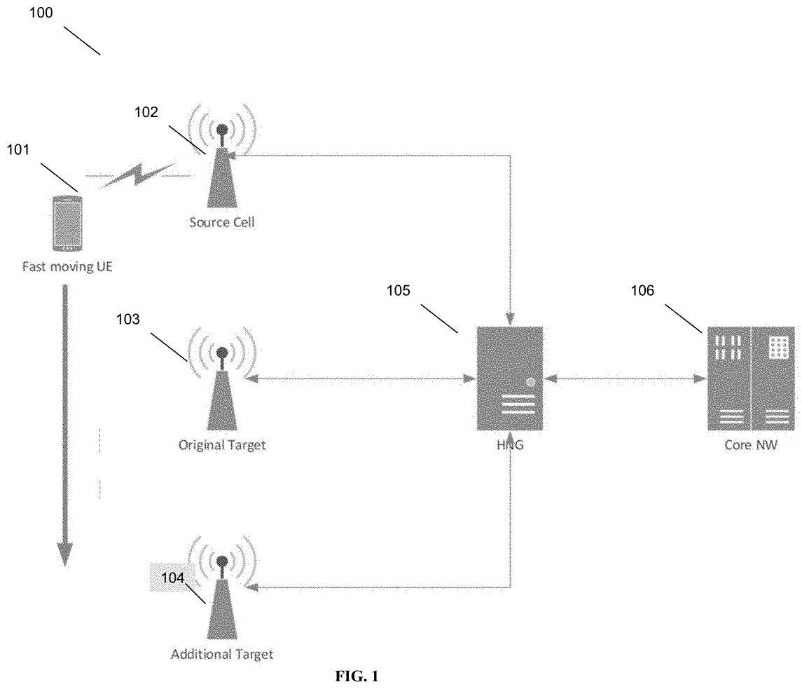

Referring now to FIG. 1, a system 100 for performing forked handover is shown. The system includes a fast moving UE 101, a source cell 102, an original target cell 103 and an additional target cell 104. The cells 102, 103, and 104 are in wireless communication with an HNG 105, which is in communication with a core network 106.

In this use case, a fast moving user reports the neighboring cell as the best in signal quality. The source cell initiates the handover, but during the process of handover, the user moves away and can only latch on to the next cell down the road.

When the UE latches on to un-prepared cell, the data path breaks and then UE has to perform Service Request to build it again. One wrong handover decision leads to after effects that are possibly visible to the actual user (e.g. stalled video playback) and of course to the whole network in terms of increased signaling.

### Solution to Problem

There are many different solutions to address this problem:

Tuning the radio coverage aspects by adjusting the power level of neighbors. This would result in better handover decisions.

Tuning the handover parameters, UE measurement periods. Again, this would help in taking better handover decisions.

When the UE latches on to a different target cell, the cell can use X2 protocol to fetch the UE context from the source cell so that NAS signaling connection need not to be re-established.

Forward Handover/Handover forking—where multiple targets are prepared in advance for anticipated UE handover.

All the approaches have some or other limitations. It is proposed that the Forward handover/Handover Forking approach is most optimal.

Parallel Wireless solution has a component called HetNet Gateway (HNG). The solution proposes HNG to do handover forking, i.e. prepare multiple adjacent target cells. It catches most of scenarios for handover to succeed. Even if UE latches on to the wrong cell, it is most possibly has been prepared by the HNG and hence handover can succeed.

Architecture Diagram

Call flow with a method to fork the handover is as shown below:

Salient Points:

HNG which is in the path of signaling builds a cache of all the neighbors of a given cell based on the record of handovers occurring to and from this cell. HNG keeps updating this cache frequently based on the amount of handovers and organizes the list in the decreasing order of handover counts, i.e. most frequented neighbor to least frequented one. When the handover forking decision is to be made, HNG uses above information to decide on what are the most probable adjacent cells where UE may land up on if it does not go to the actual target. HNG being in the data path can duplicate the indirect forwarding data packets coming in from source and then send them to all the prepared targets. HNG takes care of cancelling the handovers from all the other targets other than the one which catches the UE and sends Handover Notify message.

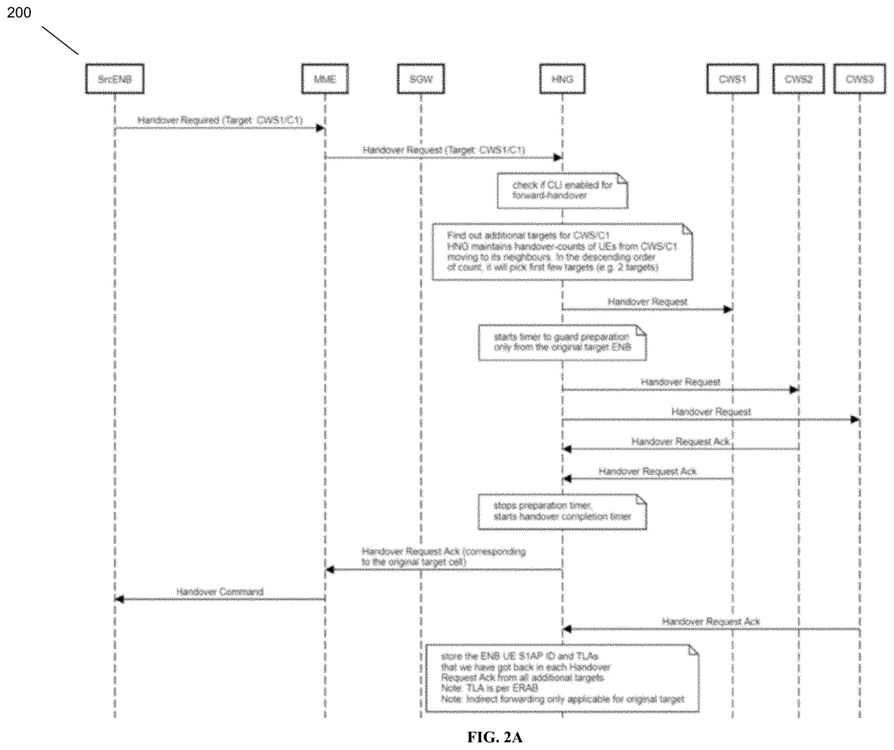

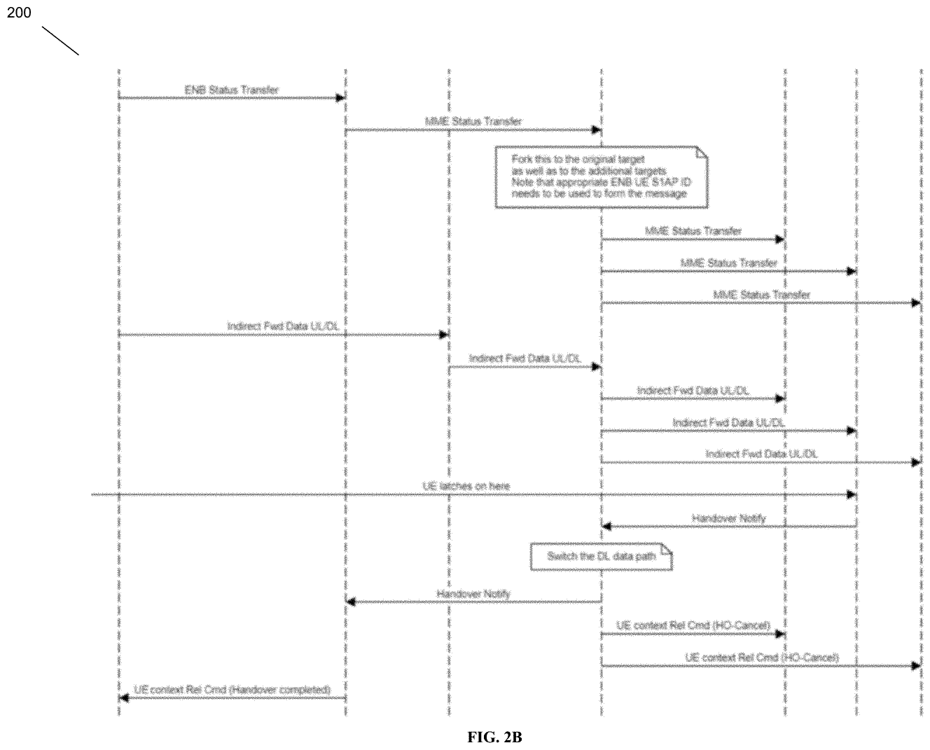

FIGS. 2A and 2B is a diagram for a call flow 200 for performing forward handover. The HNG builds a cache of all neighbors of a source cell; organizes a list of cells, the list including an original target cell and at least one additional target cell. When a handover determination is to be made, the system determines the most probable additional cells where a User Equipment (UE) may land if it does not go to the original target cell. The HNG duplicates indirect forwarding data packets coming in from the UE and sends the packets to all additional target cells. The HNG cancels handovers from all cells other than the target cell target which catches the UE.

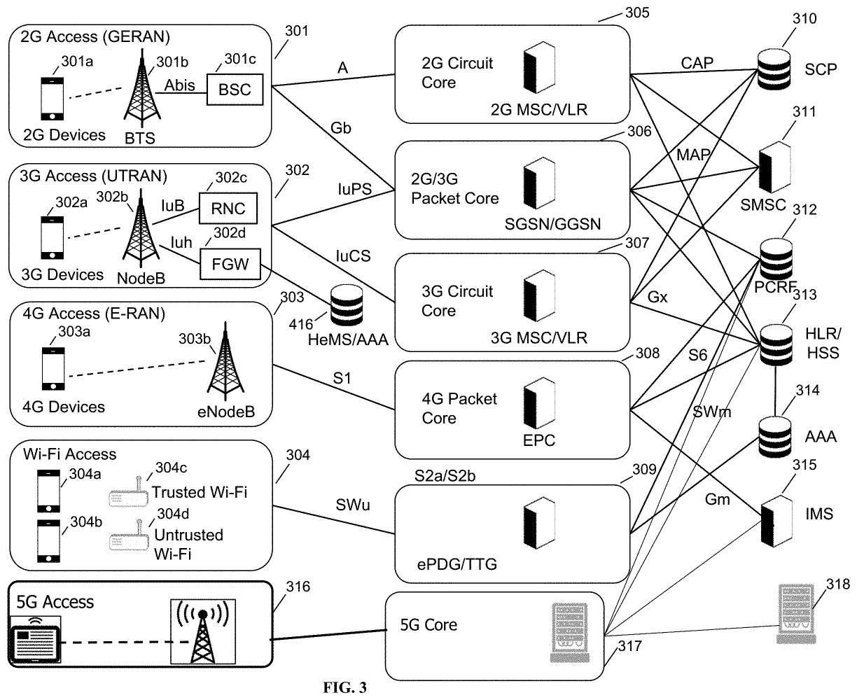

FIG. 3 is a schematic network architecture diagram for 3G and other-G prior art networks. The diagram shows a plurality of “Gs,” including 2G, 3G, 4G, 5G and Wi-Fi. 2G is represented by GERAN 101, which includes a 2G device 301a, BTS 301b, and BSC 301c. 3G is represented by UTRAN 302, which includes a 3G UE 302a, nodeB 302b, RNC 302c, and femto gateway (FGW, which in 3GPP namespace is also known as a Home nodeB Gateway or HNBGW) 302d. 4G is represented by EUTRAN or E-RAN 303, which includes an LTE UE 303a and LTE eNodeB 303b. Wi-Fi is represented by Wi-Fi access network 304, which includes a trusted Wi-Fi access point 304c and an untrusted Wi-Fi access point 304d. The Wi-Fi devices 304a and 304b may access either AP 304c or 304d. In the current network architecture, each “G” has a core network. 2G circuit core network 305 includes a 2G MSC/VLR; 2G/3G packet core network 306 includes an SGSN/GGSN (for EDGE or UMTS packet traffic); 3G circuit core 307 includes a 3G MSC/VLR; 4G circuit core 308 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 330, the SMSC 331, PCRF 332, HLR/HSS 333, Authentication, Authorization, and Accounting server (AAA) 334, and IP Multimedia Subsystem (IMS) 335. An HeMS/AAA 336 is present in some cases for use by the 3G UTRAN. The diagram is used to indicate schematically the basic functions of each network as known to one of skill in the art, and is not intended to be exhaustive. For example, 5G core 317 is shown using a single interface to 5G access 316, although in some cases 5G access can be supported using dual connectivity or via a non-standalone deployment architecture.

Noteworthy is that the RANs 301, 302, 303, 304 and 336 rely on specialized core networks 305, 306, 307, 308, 309, 337 but share essential management databases 330, 331, 332, 333, 334, 335, 338. More specifically, for the 2G GERAN, a BSC 301c is required for Abis compatibility with BTS 301b, while for the 3G UTRAN, an RNC 302c is required for Iub compatibility and an FGW 302d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

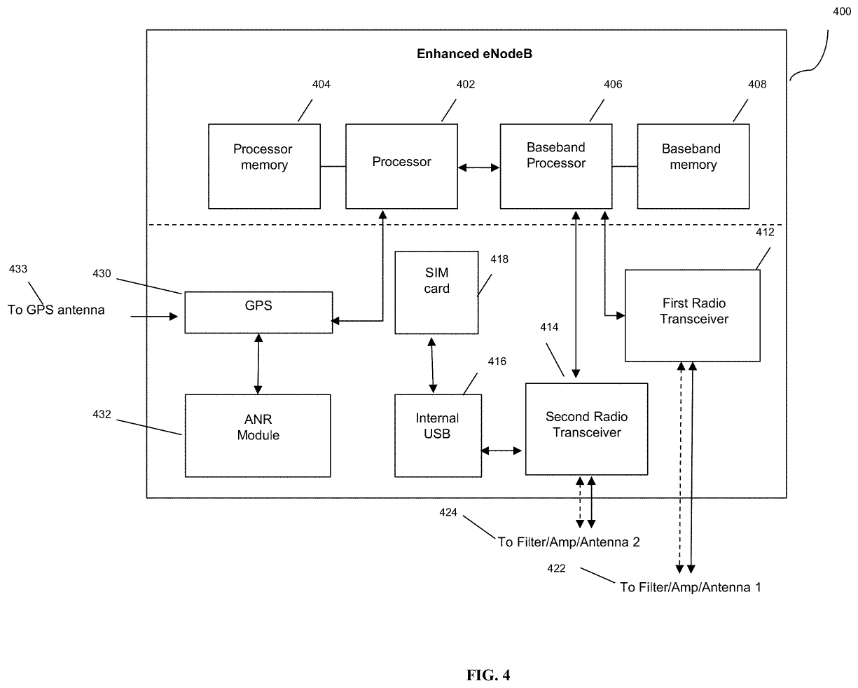

FIG. 4 is a block diagram of an enhanced eNodeB for performing the methods described herein, in accordance with some embodiments. eNodeB 400 may include processor 402, processor memory 404 in communication with the processor, baseband processor 406, and baseband processor memory 408 in communication with the baseband processor. Mesh network node 400 may also include first radio transceiver 412 and second radio transceiver 414, internal universal serial bus (USB) port 416, and subscriber information module card (SIM card) 418 coupled to USB port 416. In some embodiments, the second radio transceiver 414 itself may be coupled to USB port 416, and communications from the baseband processor may be passed through USB port 416. The second radio transceiver may be used for wirelessly backhauling eNodeB 400.

Processor 402 and baseband processor 406 are in communication with one another. Processor 402 may perform routing functions, and may determine if/when a switch in network configuration is needed. Baseband processor 406 may generate and receive radio signals for both radio transceivers 412 and 414, based on instructions from processor 402. In some embodiments, processors 402 and 406 may be on the same physical logic board. In other embodiments, they may be on separate logic boards.

Processor 402 may identify the appropriate network configuration, and may perform routing of packets from one network interface to another accordingly. Processor 402 may use memory 404, in particular to store a routing table to be used for routing packets. Baseband processor 406 may perform operations to generate the radio frequency signals for transmission or retransmission by both transceivers 410 and 412. Baseband processor 406 may also perform operations to decode signals received by transceivers 412 and 414. Baseband processor 406 may use memory 408 to perform these tasks.

The first radio transceiver 412 may be a radio transceiver capable of providing LTE eNodeB functionality, and may be capable of higher power and multi-channel OFDMA. The second radio transceiver 414 may be a radio transceiver capable of providing LTE UE functionality. Both transceivers 412 and 414 may be capable of receiving and transmitting on one or more LTE bands. In some embodiments, either or both of transceivers 412 and 414 may be capable of providing both LTE eNodeB and LTE UE functionality. Transceiver 412 may be coupled to processor 402 via a Peripheral Component Interconnect-Express (PCI-E) bus, and/or via a daughtercard. As transceiver 414 is for providing LTE UE functionality, in effect emulating a user equipment, it may be connected via the same or different PCI-E bus, or by a USB bus, and may also be coupled to SIM card 418. First transceiver 412 may be coupled to first radio frequency (RF) chain (filter, amplifier, antenna) 422, and second transceiver 414 may be coupled to second RF chain (filter, amplifier, antenna) 424.

SIM card 418 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 400 is not an ordinary UE but instead is a special UE for providing backhaul to device 400.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 412 and 414, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 402 for reconfiguration.

A GPS module 430 may also be included, and may be in communication with a GPS antenna 432 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 432 may also be present and may run on processor 402 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

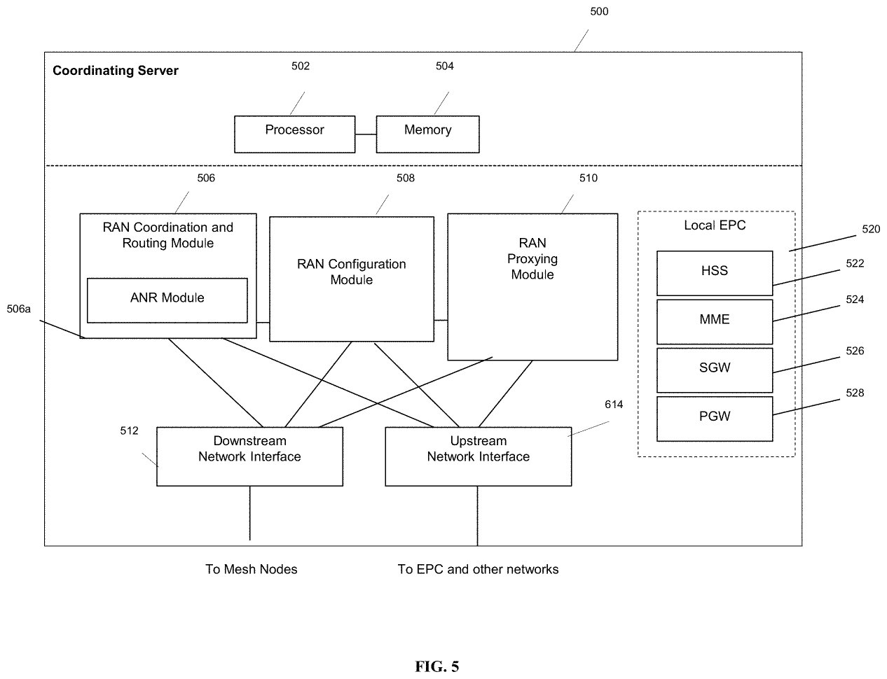

FIG. 5 is a block diagram of a coordinating server for providing services and performing methods as described herein, in accordance with some embodiments. Coordinating server 500 includes processor 502 and memory 504, which are configured to provide the functions described herein. Also present are radio access network coordination/routing (RAN Coordination and routing) module 506, including ANR module 506a, RAN configuration module 508, and RAN proxying module 510. The ANR module 506a may perform the ANR tracking, PCI disambiguation, ECGI requesting, and GPS coalescing and tracking as described herein, in coordination with RAN coordination module 506 (e.g., for requesting ECGIs, etc.). In some embodiments, coordinating server 500 may coordinate multiple RANs using coordination module 506. In some embodiments, coordination server may also provide proxying, routing virtualization and RAN virtualization, via modules 510 and 508. In some embodiments, a downstream network interface 512 is provided for interfacing with the RANs, which may be a radio interface (e.g., LTE), and an upstream network interface 514 is provided for interfacing with the core network, which may be either a radio interface (e.g., LTE) or a wired interface (e.g., Ethernet).

Coordinator 500 includes local evolved packet core (EPC) module 520, for authenticating users, storing and caching priority profile information, and performing other EPC-dependent functions when no backhaul link is available. Local EPC 520 may include local HSS 522, local MME 524, local SGW 526, and local PGW 528, as well as other modules. Local EPC 520 may incorporate these modules as software modules, processes, or containers. Local EPC 520 may alternatively incorporate these modules as a small number of monolithic software processes. Modules 506, 508, 510 and local EPC 520 may each run on processor 502 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method for providing forked handover, comprising:
building, by a HetNet Gateway (HNG), a cache of all neighbors of a source cell;
organizing a list of cells, the list including an original target cell and at least one additional target cell;
when a handover determination is to be made, determining the most probable additional cells where a User Equipment (UE) may land if it does not go to the original target cell;
duplicating, by the HNG, indirect forwarding data packets coming in from the UE and sending the packets to all additional target cells; and
canceling, by the HNG, handovers from all cells other than the target cell target which catches the UE.

2. The method of claim 1 wherein the building a cache of all neighbors of the source cell is based on a record of handovers occurring to or from the original target cell.

3. The method of claim 1 wherein the organizing a list of cells comprises organizing the list of cells by decreasing order of handover counts.

4. The method of claim 1 wherein the canceling handovers from all cells other than the target cell which catches the UE further comprises sending a handover notify message.

5. The method of claim 1 wherein the UE is moving.

6. A system for providing forked handover, comprising:
a HetNet Gateway (HNG) in communication with a source cell, an original target cell, and an additional target cell;
wherein the HNG builds a cache of all neighbors of a cell;
organizes a list of cells;
when a handover determination is to be made, determining the most probable adjacent cells where a User Equipment (UE) may land if it does not go to an actual target;
duplicating indirect forwarding data packets coming in from a source and send the packets to all prepared cells; and
canceling handovers from all cells other than the cell target which catches the UE.

7. The system of claim 6 wherein the cache of all neighbors of the source cell is based on a record of handovers occurring to or from the original target cell.

8. The system of claim 6 wherein the list of cells comprises a list of cells organized by decreasing order of handover counts.

9. The system of claim 6 wherein the canceling handovers from all cells other than the target cell which catches the UE further comprises sending a handover notify message.

10. The system of claim 6 wherein the UE is moving.

11. A non-transitory computer-readable medium containing instructions for providing forked handover, which, when executed, cause a system to perform steps comprising:
building, by a HetNet Gateway (HNG), a cache of all neighbors of a source cell;
organizing a list of cells, the list including an original target cell and at least one additional target cell;
when a handover determination is to be made, determining the most probable additional cells where a moving User Equipment (UE) may land if it does not go to the original target cell;
duplicating, by the HNG, indirect forwarding data packets coming in from the UE and sending the packets to all additional target cells; and
canceling, by the HNG, handovers from all cells other than the target cell target which catches the UE.

12. The computer-readable medium of claim 11 wherein the instructions for building a cache of all neighbors of the source cell is based on a record of handovers occurring to or from the original target cell.

13. The computer-readable medium of claim 11 wherein the instructions for organizing a list of cells comprises instructions for organizing the list of cells by decreasing order of handover counts.

14. The computer-readable medium of claim 11 wherein the instructions for canceling handovers from all cells other than the target cell which catches the UE further comprises instructions for sending a handover notify message.
